(19) United States
(12) Patent Application Publication
(10) Pub. No.: US 2014/0019830 A1
(43) Pub. Date: Jan. 16, 2014

(54) Joint application-layer forward error/erasure correction (FEC) and video coding

(71) Applicant: Broadcom Corporation, Irvine, CA (US)

(72) Inventors: Peisong Chen, San Diego, CA (US); Ba-Zhong Shen, Irvine, CA (US)

(73) Assignee: BROADCOM CORPORATION, IRVINE, CA (US)

(21) Appl. No.: 13/942,924

(22) Filed: Jul. 16, 2013

Related U.S. Application Data
(60) Provisional application No. 61/672,248, filed on Jul. 16, 2012.

(51) Int. Cl. H04L 1/00

(52) U.S. Cl. CPC H04L 1/004
USPC 714/776; 370/389

(57) ABSTRACT

Layered and scalable coding scheme is applied to one or more communication pathways between a transmitter and one or more receivers. Forward error/erasure correction (FEC) is applied for application layer erasure recovery. Additional FEC may also be employed at the physical layer (PHY) layer or channel coding layer for additional error correction capability and to provide joint application and PHY layer FEC coding. Source information (e.g., data, media such as image, video or audio, etc., or any other type of information) is encoded using two or more layers. These layers may include a base layer and one or more enhancement layers that, when combined with the base layer, modify the quality of the base layer. In a packet-based application, transmission of redundancy packets may be separately time-limited in the two or more layers. Also, adaptation (of signaling, FEC, etc.) may be made based on operating condition changes.

### CROSS REFERENCE TO RELATED PATENTS/PATENT APPLICATIONS

### Provisional Priority Claims

The present U.S. Utility Patent Application claims priority pursuant to 35 U.S.C. §119(e) to the following U.S. Provisional Patent Application which is hereby incorporated herein by reference in its entirety and made part of the present U.S. Utility Patent Application for all purposes:
1. U.S. Provisional Patent Application Ser. No. 61/672,248, entitled “Joint application-layer forward error correction (FEC) and video coding,” filed Jul. 16, 2012, pending.

### BACKGROUND

1. Technical Field

The present disclosure relates generally to communication systems; and, more particularly, to scalable or layered coding within such communication systems.

2. Description of Related Art

Communication systems can include one or more communication pathways that are lossy in which information may become distorted or even lost during transmission between various communication devices within such communication systems. Within packet based communication systems, a packet erasure channel is one in which a transmitted packet is either received (possibly with some distortion) or lost entirely. Typically, the location of any packet lost within communication may be determined.

Within packet-based communication systems such as broadcasting or streaming applications, packets must be delivered in a timely manner for a satisfactory user experience. For example, if one or more packets are lost, a receiving communication device must be able to extract information from the received packets in order to produce the information sent in by the transmitting communication device, including one or more lost packets, and to maintain the order of the information. In certain prior art broadcasting or streaming based communication systems, information is transmitted using a common set of signaling parameters. For example, a least common denominator approach is typically performed based on a worst-performing communication pathway within the system. As such, a given set of worst-case signaling parameters is used for transmission via all of the respective pathways between the broadcasting communication device and the various recipient communication devices. This can limit the overall throughput within the system because certain communication pathways are forced to support communications at rates lower than relatively higher throughput rates that they can support. As such, the user experience associated with some of the recipient communication devices may be less than optimal.

### BRIEF DESCRIPTION OF THE SEVERAL VIEWS OF THE DRAWINGS

FIG. 1 is a diagram illustrating an embodiment of one or more communication systems.

FIG. 2 is a diagram illustrating an example of communication from one communication device to one or more other communication devices.

FIG. 3A is a diagram illustrating an example of scalable or layered encoding of source information.

FIG. 3B is a diagram illustrating another example of scalable or layered encoding of source information including using different codes and redundancy time limits.

FIG. 4A is a diagram illustrating an example of a communication device recovering base layer information to generate a base level quality signal.

FIG. 4B is a diagram illustrating an example of a communication device recovering first enhancement layer information to generate a first enhanced level quality signal.

FIG. 4C is a diagram illustrating an example of a communication device recovering multiple enhancement layer information to generate a highest enhanced level quality signal.

FIG. 5 is a diagram illustrating an embodiment of communication between two communication devices via a packet erasure pathway.

FIG. 6A is a diagram illustrating an embodiment of a method for execution by one or more communication devices.

FIG. 6B is a diagram illustrating another embodiment of a method for execution by one or more communication devices.

FIG. 7A is a diagram illustrating another embodiment of a method for execution by one or more communication devices.

FIG. 7B is a diagram illustrating another embodiment of a method for execution by one or more communication devices.

### DETAILED DESCRIPTION

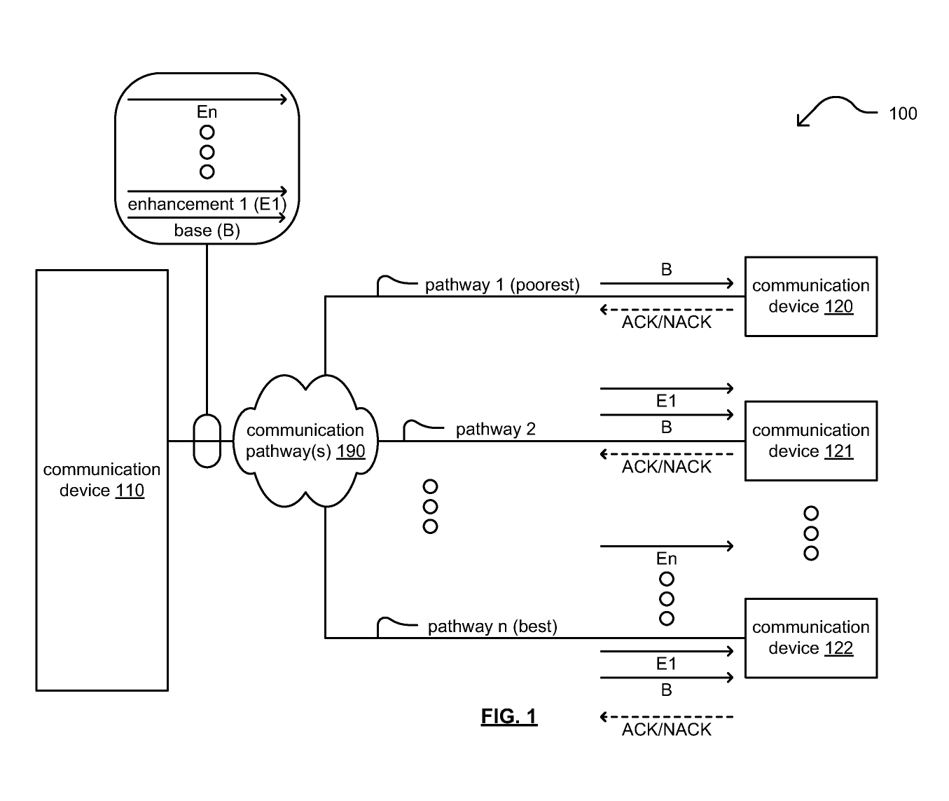

FIG. 1 is a diagram illustrating an embodiment 100 of one or more communication systems. A communication system includes at least two communication devices communication devices 110 and 120. In some instance, the communication system also includes additional communication devices 121 and 122.

Each of the communication devices 110, 120-122 may be stationary or mobile devices. For example, a mobile device may be any one of a cellular telephone, a tablet, a laptop computer, a video game console, a multimedia (e.g., audio and/or video) player, etc. One type of stationary communication device is a one that, while it can be moved, is generally used at a fixed location such as a computer, an access point, a cable or set top box, a router, etc. Another type of stationary communication device is one that is not moved after installation (e.g., cable headend transmitter, cable modem termination system (CMTS), cellular tower, microwave transceiver, etc.).

The device 110 communicates with devices 120-122 via one or more communication pathways 190 in accordance with one or more communication protocols and/or standards. The one or more communication pathways 190 may include wired, wireless, optical, etc. communication pathways. The various one or more communication pathways 190 may be different links within a singular communication channel or media (e.g., different respective wireless links or pathways between a transmitter and one or more receivers in a wireless or air-based-media communication system; alternatively, different respective wired links or pathways between a transmitter and one or more receivers in a wired-based-media communication system). The various one or more communication pathways 190 may also include one or more communication links implemented using two or more singular communication channels or media (e.g., a first communication pathway that includes a first pathway via a wired path and a second pathway via a wireless path, etc.; alternatively a second communication pathway that includes a first pathway via a first one or more communication networks and a second pathway via a second one or more communication networks, which may include at least one link within the first one or more communication networks; etc.).

The communication device 110 generates and transmits the same packets to the devices 120-122 using two or more layers and via the one or more pathways, but, depending on the particular characteristics of a given pathway between device 110 and the devices 120-122, any one of the devices 120-122 may not successfully receive all of the packets of the two or more layers transmitted from the communication device 110. As such, a communication interface of the device 110 transmits information to devices 120-122 in a scalable or layered manner. Operation of the device 110's communication interface may be directed by a processor within the communication device 110, based on any one or more considerations. The device 110 transmits packets within a base layer (B) using signaling parameters that are selected based on a worst-performing communication pathway of the one or more communication pathways 190 (i.e., the poorest communication pathway between device 110 and devices 120-122).

All of the devices 120-122 should be able and/or generally guaranteed to receive the packets via the base layer. The device 110 also transmits other packets via at least one enhancement layer (El) using signaling parameters that are selected based on a better-performing communication pathway. Such an enhancement layer, when combined with the base layer, modifies the quality of the base layer (e.g., improves quality of information transmitted via the base layer). The device 110 may transmit any number of additional enhancement layers using appropriate signaling parameters that are selected based on communication pathways of various qualities. The device 110 may transmit even other packets via a highest level enhancement layer (En) using signal parameters that are selected based on a best-performing communication pathway within the system. Generally speaking, the device 110 transmits different respective packets via a base layer and one or more enhancement layers to the devices 120-122, but any one of the devices 120-122 may not receive all of the packets for all of the layers (e.g., depending on the particular pathway via which the device 120-122 is in communication with the device 110).

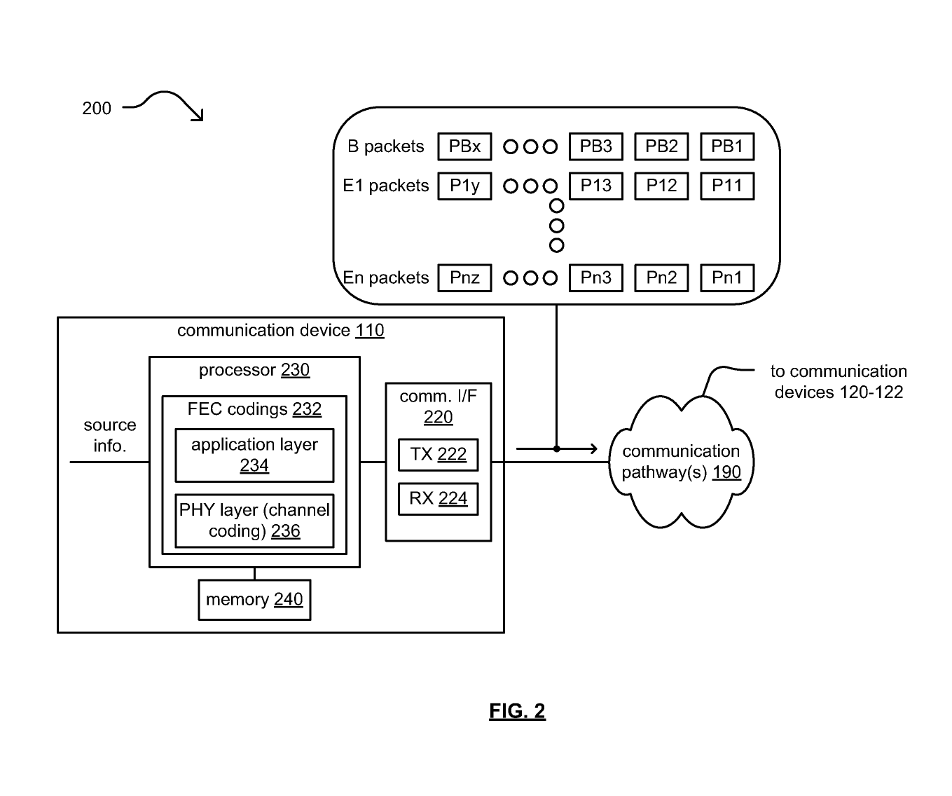

FIG. 2 is a diagram illustrating an example 200 of communication from one communication device to one or more other communication devices. Device 110 is in communication with devices 120-122 via one or more communication pathways 190 that may have different signal carrying capacities. The information communicated between devices 110 and 120-122 may be of any type including data, media (such as video and/or audio), etc. These pathways may exist via one or more communication networks of various types including the Internet, proprietary networks, cellular networks, telephone networks, etc. The communication media of such communication networks may be varied and include communication links of one or more types of media including wired, wireless, optical, satellite, etc. communication links and/or media. Any one pathway may include multiple links through multiple communication networks.

Device 110 includes a communication interface 220 configured to perform transmitting and receiving of one or more packets (e.g., using a transmitter 222 and a receiver 224). Device 110 also includes a processor 230, and an associated memory 240, to execute various operations including generation of packets, encoding of source information using any of various types of forward error/erasure correction (FEC) coding, etc. As one of average skill in the art will appreciate, the devices 110 and 120-122 of FIG. 1 and FIG. 2 may be implemented using one or more integrated circuits in accordance with any desired configuration or combination or components, modules, etc. within one or more integrated circuits. The communication interface 220 of the device 110 is configured to transmit base layer packets via a first layer and one or more enhancement layer's packets via one or more additional layers to the devices 120-122.

In an example of operation, device 110 broadcasts or streams packets to multiple recipient devices 120-122 using two or more layers via one or more communication pathways 190. In a broadcast or streaming applications, device 110 transmits the same packets to the devices 120-122 via the two or more layers, but those packets may not be received by all of the devices 120-122 (e.g., due to packet erasure within one or more of the pathways). The base layer includes B packets shown as PB1, PB2, and so on up to PBx. A first enhancement layer includes El packets shown as P11, P12, and so on up to P1y. Any desired number of additional enhancement layers may be employed. A highest level enhancement layer includes En packets shown as Pn1, Pn2, and so on up to Pnz. Device 110 is configured to perform layer dependent FEC coding, layer dependent signaling, and layer dependent redundancy packet transmission. For example, device 110 is configured to apply different respective FEC codings 232, signaling, and redundancy packet transmission time limitation to each of the respective layers that are transmitted from device 110 to devices 120-122. The communication interface 220 of communication device 110 transmits the packets to devices 120-122 in a scalable or layered manner such that different signaling parameters and redundancy time limits may be applied to the different respective layers.

As an example of operation, the communication interface 220 transmits the base layer packets using a first signaling parameter(s) (e.g., 1^{st} modulation, 1^{st} bit rate, 1^{st} symbol rate, etc.) and transmits the first enhancement layer packets using a second signaling parameter(s) (e.g., 2^{nd} modulation that is of higher order than the 1^{st} modulation, 2^{nd} bit rate that is greater than the 1^{st} bit rate, 2^{nd} symbol rate that is greater than the 1^{st} bit rate, etc.). For some examples: 1^{st} modulation may be 64 QAM and 2^{nd} modulation may be 128 QAM; 1^{st} bit rate may be X bits per second and 2^{nd} bit rate may be Y bits per second, where X and Y are integers and Y>X; 1^{st} symbol rate may be A symbols per second and 2^{nd} symbol rate may be B symbols per second, where B and A are integers and B>A.

Also, different signaling schemes may be employed via the different layers (e.g., single carrier via one layer, orthogonal frequency division multiplexing (OFDM) via another layer, code division multiple access (CDMA) via yet another layer, etc.).

Also, the processor 230 of the device 110 is configured to apply FEC coding at both an application layer 234 and a physical layer (PHY) (or channel coding) layer 236. Generally, the PHY layer 236 defines the electrical and physical specification for communication of signals between devices via one or more transmission media, and the application layer 234 is a layer relatively closest to an end-user or operator of a device. The application layer 234 may be viewed as a layer that interacts with software applications at a relatively highest level (e.g., on the Transmission Control Protocol/Internet Protocol (TCP/IP) stack in Internet related applications such as Hypertext Transfer Protocol (HTTP), File Transfer Protocol (FTP), etc.). As one of average skill in the art will appreciate, the Open Systems Interconnection (OSI) model provided by the Open Systems Interconnection project at the International Organization for Standardization (ISO) has provided a 7 layer model that includes a (highest) application layer, a presentation layer, a session layer, transport layer, a network layer, a data link layer, and a (lowest) physical layer (PHY) layer. Processor 230 applies FEC coding at the application layer 234 in generating the base layer packets and the one or more enhancement layer's packets. Processor 230 may also apply FEC coding at the physical layer (PHY) (or channel coding) layer 236 just before such packets undergo transmission from the communication device 110 into the one or more communication pathways 190. Again, depending on the characteristics of any one of the one or more communication pathways 190, all of the packets transmitted by the communication device 110 may not be received by the devices 120-122 (e.g., as shown in FIG. 1, communication device 120 may receive only packets via the base layer and communication device 121 may receive only packets via the base and first enhancement layers). By the communication interface of the device 110 transmitting information to devices 120-122 in a scalable or layered manner, any one of the devices 120-122 may lock onto and use packets of at least the base layer and, when successfully received, packets of one or more higher layers to recover transmitted information. In addition, as the information carrying capacity (conditions) of a pathway via which one of the devices 120-122 receives packets varies, that one of the devices 120-122 can lock onto packets of the base layer and a different enhancement layer (e.g., a relatively higher level enhancement layer as conditions improve or a relatively lower level enhancement layer as conditions degrade).

A communication pathway may be lossy such that some information transmitted via the pathway may be adversely affected or even lost entirely. In packet-based systems (e.g., Internet), a packet erasure pathway is one in which any given packet is either successfully transmitted between devices or lost entirely. In other words, a receiver device that receives packet via a packet erasure pathway will either receive a transmitted packet (which may be channel affected) or not receive the packet at all. The device 110 applies forward error/erasure correction (FEC) coding to signals transmitted to the devices 120-122. Generally, FEC coding (e.g., error correction code (ECC), forward error/erasure correction (FEC), etc.) operates to reduce transmission errors and/or lower signal to noise ratio (SNR) while achieving a desired bit error rate (BER) of a communication pathway or channel.

The communication device 110 employs any of a number of different types of FEC to provide redundancy to information within signals transmitted to the devices 120-122 so they can recover information within the signals even in the event information being adversely affected or lost during transmission. Examples of some types of FEC coding include repetition, rateless/rate-independent, Reed-Solomon (RS), convolutional, turbo, turbo trellis coded modulation (TTCM), low density parity check (LDPC), BCH (Bose and Ray-Chaudhuri, and Hocquenghem), supercharged, hybrid automatic repeat request (HARM) such as based on Release 11 of LTE (Long Term Evolution, marketed as 4G LTE), etc. and/or any combination of such codings including uncoded modulation.

In addition, device 110 applies one or more signaling parameters to the layers of signals transmitted to the devices 120-122 based on one or more characteristics of the pathway between the devices. For example, pathway 1 between device 110 and 120 is relatively the poorest quality communication pathway in the system. Various characteristics may characterize the pathway being poor including relatively low signal to noise ratio (SNR), interference, noise, relatively high or highest number of lost packets, etc. Analogously, other characteristics may characterize a pathway as being relatively the best including relatively high SNR, lowest number of lost packets, etc. One or more signaling parameters may include modulation (e.g., from relatively low modulations such as quadrature phase shift keying (QPSK, or 4 quadrature amplitude modulation [4 QAM]), 8 phase shift keying (8-PSK), 16 QAM, 16 amplitude phase shift keying (APSK)), but may be even more operative to provide efficiencies for even large signaling constellations (e.g., 64 quadrature amplitude modulation (QAM), 256 QAM, 1024 QAM, etc.), bit or symbol rate, code type of any FEC coding applied, rate of any FEC coding applied, etc.

Generally, a relatively higher quality communication pathway supports relatively less robust signaling parameters (e.g., codes with lower error correction capability, higher code rates, higher ordered modulations, etc.) that allow for greater throughput while a relatively lower quality communication pathway requires relatively more robust signaling parameters (e.g., codes with higher error correction capability, lower code rates, lower ordered modulations, etc.) that limit the amount of throughput yet provide for a higher likelihood of successful receipt by a receiver device. As the quality of any communication pathway may vary over time, device 110 may modify any such signaling parameter appropriately (e.g., increase robustness as the communication pathway's quality diminishes or increased throughput as the communication pathway's quality improves).

Considering a packet-based system, the device 110 generates base layer packets that include base layer redundancy packets for the base layer. Analogously, the device 110 generates enhancement layer packets that include enhancement layer redundancy packets for one or more enhancement layers. The device 110 transmits the base layer packets and the enhancement layer packets to devices 120-122. However, given the quality of the various communication pathways between these devices, a given recipient device 120-122 may not be able to receive all of the enhancement layer packets. As an example, device 120 is shown as receiving via only the base layer. Device 121 is shown as receiving via the base layer and also a first enhancement layer. Device 122 is shown as receiving via the base layer and multiple enhancement layers. In broadcasting or streaming applications, the device 110 may transmit packets associated with each layer based on corresponding redundancy time limits. Device 110 limits the amount of time during which it will transmit information associated with any given packet (including any redundancy packet corresponding to that packet). Without any such limit, such broadcasting or streaming may freeze or hang and adversely affect a user's experience.

Device 110 sets a limit on the transmission of redundancy packets to ensure continual flow of the broadcasted or streamed information. For example, device 110 will transmit the base layer packets using a first redundancy time limit and will transmit a given enhancement layer's packets using a second redundancy time limit. Device 110 employs layer dependent time limitations for each of the respective layers (e.g., base and one or more enhancement layers) that are transmitted to devices 120-122. For any given layer, the device 110 may set a respective redundancy time limit based on an acknowledgement/non-acknowledgement (ACK/NACK) received from one of the devices 120-122. For example, when a given recipient device 120-122 receives (or does not receive) enough redundancy packets that it may successfully recover information transmitted from device 110, which recipient device 120-122 will provide an ACK or NACK.

Communication of information from communication device 110 to communication devices 120-122 may be made using multicast. For example, multicast operations may be made using one or more communication standards, developing standards, and/or recommended practices including those associated with Long Term Evolution (LTE), Evolved Multimedia Broadcast Multicast Service (eMBMS), etc. Some applications operate by allowing information (e.g., multimedia content) to be sent once by communication device 110 and received by many end users, communication devices 120-122.

For example, during live broadcasting or streaming of media (e.g., major sports or news events), unicast transmission operates by sending the same media (e.g., video) to every recipient or end user individually. In comparison, multicast operates by taking advantage of the inherent broadcast characteristics and/or qualities existent within wireless networks to send the video only once to reach a number of recipients or end users. In this case, a recipient communication device 120-122 has no capability to choose and can feedback acknowledge once (or not at all) to the communication device 110. Therefore, such a system gives a tremendous bandwidth saving and video traffic reduction. Also, to increase the transmission reliability (e.g., mitigate or eliminate packet drop, or protect against such packet drop), an application layer erasure recovery (e.g., forward error/erasure correction (FEC)) coding may be used.

Considering an example application of eMBMS, the throughput may be viewed as being based on the worst-performing communication pathway in the one or more networks. Multicast consumes the communication network's bandwidth and/or resources equivalent to the worst link of the communication network.

As such, processor of communication device 110 performs FEC coding to generate sufficient redundancy packets for the worst-performing communication pathway within the communication network to allow recovery of the source information packets of a first source information block before communication device 110 begins transmitting the next source information block and generate next repair blocks. Such FEC may be referred to as a rateless (or rate independent) FEC since the FEC code rate is not directly dependent on every single recipient or end user.

Evolved Multimedia Broadcast Multicast Service (eMBMS) related applications may be directed towards video broadcasting and/or streaming. In such applications, further throughput improvement can be achieved by joint application-layer forward erasure correct (AL-FEC) coding and video coding. Since the throughput for eMBMS is based on the worst-performing link, the throughput of the multicast system is thereby also limited by the worst-performing communication pathway. To improve the system throughput, layered or scalable source coding may be combined with this AL-FEC. In certain practical application scenarios (e.g., video broadcasting and/or streaming), one or more redundancy time limits may be set on the transmission of redundancy packets. Beyond a given time limit, there is no more transmission of redundancy packets, and the communication device continues on to transmit packets associated with a next source block.

Generally speaking, source information (e.g., data, video, audio, etc.) is encoded into layered or scalable bistreams. In one example with two-layer scalability, a base layer and an enhancement layer are employed. However, it is noted that any desired degree of multiple layer scalability may alternatively be employed (e.g., beyond only 2 layers, which generally can included N layers, where N is an integer).

The enhancement layer (one layer within a two or more layers of scalability) may enhance the resolution, frame rate or quality of the base layer. Also, in time-limited transmission of redundancy packets, different respective time limits can be set for the different respective layers (e.g., the base and the one or more enhancement layers). For example, a relatively larger time value may be employed one of the layers and a relatively smaller time value for at least one another of the layers (e.g., a relatively larger time value for the base layer and a relatively smaller time value for the enhancement layer). By doing this, any desired degree of tradeoff may be between throughput and user coverage. For example, in one embodiment, for those respective users with relatively poor or bad channel conditions, only the base layer may be received, while for users with relatively better or good channel conditions, both the base and the enhancement layers may be received. Adaptation and selectivity may be made between the different respective layers. Recipient communication devices may provide information regarding one or more characteristics of the one or more communication pathways via which they receive packets of one of more layers from transmitter communication device 110, and such adaptation and selectivity may be based on those characteristics. The transmitter communication device 110 may also one or more characteristics of the one or more communication pathways for use in adaptation.

Alternatively, the same time limit can be used for the base and the enhancement layers but different respective amounts of FEC redundancy can be provided. For example, the ratio of the base layer redundancy packet number and the base layer original information packets can be larger than the ratio of the enhancement layer redundancy packet number of the enhancement layer original information packets.

Considering one embodiment, the base layer source may be viewed as having a block size of B (e.g., B number of symbols), and the enhancement layer may be viewed as having a size of E (e.g., E number of symbols). If the overhead rate (e.g., percentage of the redundant FEC data) of the base layer is R_{B}, and the overhead rate of the enhancement layer is R_{E}, and R_{B}>R_{E}, then the total percentage of the redundancy is (R_{B}×B+R_{E}×E)/(B+E). If B/E=1 (e.g., both the base layer block size and the enhancement layer block size are the same size), then the redundancy is (R_{B}+R_{E})/2, which is smaller than R_{B} since R_{B}>R_{E}. As may be understood, this scalable approach provides relatively higher throughput than a single level approach.

Usually, the B/E ratio is content dependent. Rate control may be employed to force the B/E ratio to a certain value; however, such rate control may have a negative impact on the overall coding efficiency in some situations.

Since rateless/rate-independent FEC code is applied at one of the layers rather than at the other one or more layers (e.g., applied at the application layer rather than at the physical layer), relatively more flexibility may be achieved to allocate bits respective between the different respective layers (e.g., between the base layer and the enhancement video layer) and different error correction capability may also be used for the different respective layers. For example, in one embodiment, after providing sufficient FEC overhead for the base layer data, FEC overhead may be provided for the enhancement layer based on remaining bandwidth. By jointly allocating bits for the different respective layers (e.g., jointly allocating bits for the base and enhancement layers in a two-layer scalability embodiment) and also allocating FEC redundant bits at one of the respective layers (e.g., the application layer), all recipients and users may be provided a guaranteed base service and recipients and users with good signal coverage can have improved video quality. Rate-independent (e.g., rateless) FEC due as applied based on eMBMS allows for only one or no acknowledgement to be sent from any recipient communication device 120-122 to the transmitter communication device 110. Communication device 110 can encode one of the respective layers (e.g., a base layer (B) source stream) with such a rateless FEC to generate as many redundancy symbols as may be desired. Such operation may be stopped when the communication device 120-122 associated with the worst-performing communication pathway (e.g., communication device 120) is acknowledged or not (e.g., via ACK or NACK) or until the expected error probability for the worst link client is met. Communication device 110 can encode another of the layers (e.g., an enhanced layer 1 (L1) source stream) independently by a rateless encoder to generate a relatively less number or fixed number of redundancy symbols than that which is generated using a higher layers encoder. In this way, the throughput and operation of transmitter communication device 110 is improved, but any one of the recipient communication devices 120-122 that receives packets via a relatively poor communication pathway may only be able to recover a lower level layer stream such as only the base layer stream).

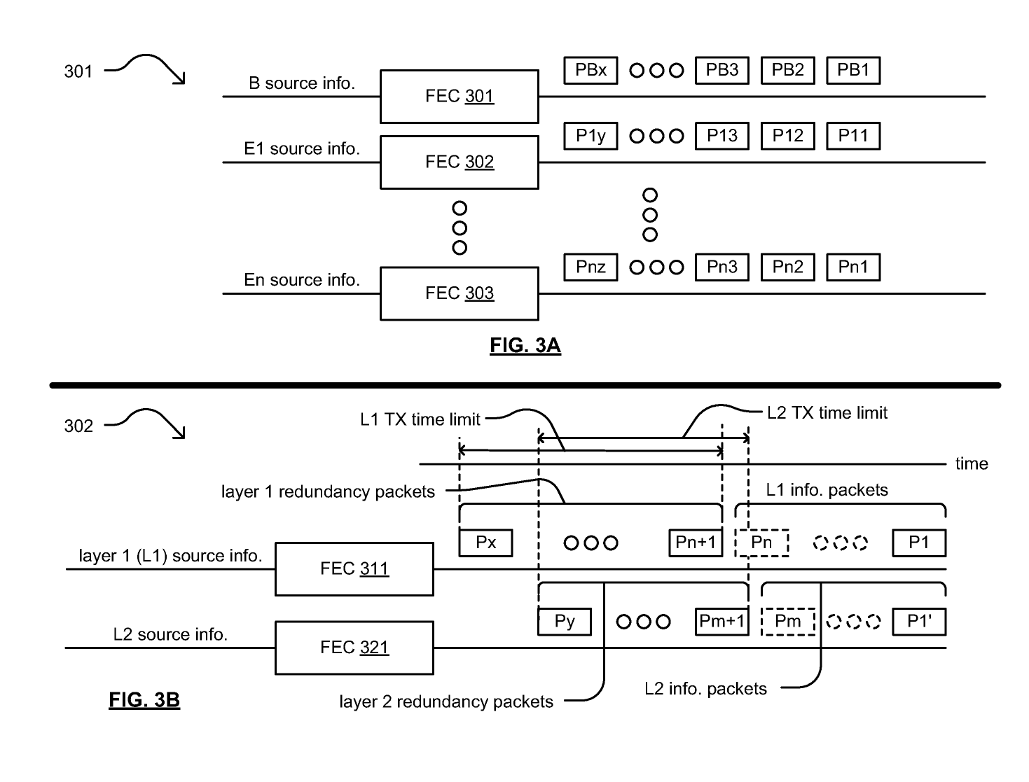

FIG. 3A is a diagram illustrating an example 301 of scalable or layered encoding of source information. A communication device, such as device 110, employs multiple respective FECs to generate various packets. For example, a device's processor employs FEC 301 to process base layer (B) source information to generate the base layer (B) packets shown as PB1, PB2, and so on up to PBx. The device's processor employs FEC 302 to process a first enhancement layer (El) source information to generate the enhancement layer El packets shown as P11, P12, and so on up to P1y. Any desired number of additional FECs may be employed to generate additional enhancement layers. The device's processor employs FEC 303 to process highest level enhancement layer (En) source information to generate the highest level enhancement layer En packets shown as Pn1, Pn2, and so on up to Pnz. Each of the various FEC's 301, 302, and so on up to 303 may be of different types, error correction capability, code rates, etc. Also, each of the various source information (e.g., base layer (B), first enhancement layer (El), and so on up to highest level enhancement layer (En)) may also be of different block size or include a different number of bits or symbols.

FIG. 3B is a diagram illustrating another example 302 of scalable or layered encoding of source information including using different codes and redundancy time limits. The device's processor employs FEC 311 to process layer 1 (L1) source information to generate the L1 packets shown as P1 through Pn (L1 information packets) and Pn+1 through Px (L1 redundancy packets). These two layers may correspond to any two layers described herein, including a base layer and/or one or more enhancement layers. The device's processor employs FEC 312 to process layer 2 (L2) source information to generate the L2 packets shown as P1′ through Pm (L2 information packets) and Pm+1 through Py (L2 redundancy packets). The FEC 311 and 321 have one or more differences based on type, error correction capability, code rate, etc. Also, the two layers shown in this diagram have different redundancy time limits (e.g., L1 TX time limit and L2 TX time limit). Generally speaking, a device's processor may employ different respective FEC's to different respective layers, and a device's communication interface may employ different respective redundancy time limits to different respective layers.

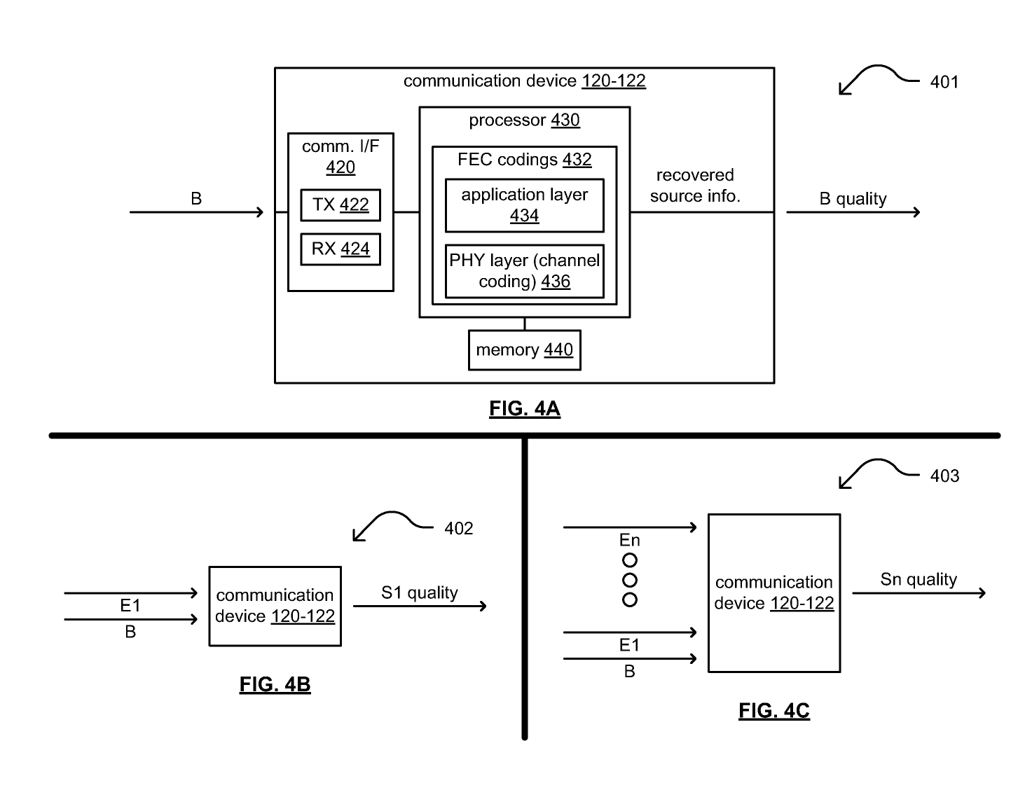

FIG. 4A is a diagram illustrating an example 401 of a communication device recovering base layer information to generate a base level quality signal. A recipient device, which may be any one of the devices 120-122, is in communication with device 110 via one or more communication pathways. Recipient device 120-122 includes a communication interface 420 to perform transmitting and receiving of one or more packets (e.g., using a transmitter 422 and a receiver 424). Recipient device 120-122 also includes a processor 430, and an associated memory 440, to execute various operations including decoding of received packets using any of various types of forward error/erasure correction (FEC) coding, combination of packets from different respective layers, etc. The communication interface 420 of the recipient device 120-122 is configured to receive base layer packets and one or more enhancement layer's packets from device 110.

Recipient device 120-122 shown in FIG. 4A is able to receive packets of the base layer. Processor 430 is configured to recover source information of that base layer. Recipient device 120-122 is then configured to generate a base layer quality signal from that recovered base layer source information.

FIG. 4B is a diagram illustrating an example 402 of a communication device recovering first enhancement layer information to generate a first enhanced level quality signal. Recipient device 120-122 shown in FIG. 4B is able to receive packets of the base layer and also of a first enhancement layer (El). Processor 430 is configured to recover source information of that base layer as well as source information of the first enhancement layer (El). Processor 430 is also configured to combine the recovered base layer source information and the recovered first enhancement layer source information to generate enhanced layer information. Recipient device 120-122 is then configured to generate an enhanced level signal (S1) that is of relatively higher quality than the base layer quality signal.

FIG. 4C is a diagram illustrating an example 403 of a communication device recovering multiple enhancement layer information to generate a highest enhanced level quality signal. Recipient device 120-122 shown in FIG. 4C is able to receive packets of the base layer and also of a first enhancement layer (El), as well as packets associated with any one or more additional enhancement layers up to (En). Processor 430 is configured to recover source information of that base layer as well as source information of the first enhancement layer (El) and at least one additional enhancement layer (En). Processor 430 is also configured to combine the recovered base layer source information and the recovered source information from each of the one or more other enhancement layers to generate enhanced layer information. Recipient device 120-122 is then configured to generate enhanced level signal (Sn) that is of relatively higher quality than the base layer quality signal as well as of relatively higher quality than the enhanced level signal (S1).

Considering an example of video information being transmitted from transmitter communication device 110 to recipient devices 120-122, base layer quality signal may be a video signal having a relatively lowest resolution (e.g., 480p), first enhancement layer (El) quality signal may be a video signal having a relatively higher resolution (e.g., 710p), and enhanced level signal (Sn) may be a video signal having a relatively very high or highest resolution (e.g., 1080p). Considering an example of audio information being transmitted from transmitter communication device 110 to recipient devices 120-122, base layer quality signal may be an audio signal having a relatively lowest quality (e.g., mono), first enhancement layer (El) quality signal may be an audio signal having a relatively higher resolution (e.g., stereo), and enhanced level signal (Sn) may be an audio signal having a relatively very high or highest resolution (e.g., HD audio, multi-channel audio, etc.). Similar gradations or stratifications of quality may be made for other types of information transmitted from transmitter communication device 110 to recipient devices 120-122 as well.

Depending on the packets received by a given recipient device 120-122, which recipient device 120-122 will be able to recover source information and generate a corresponding signal for at least one of the layers. Every recipient device 120-122 should be able to recover at least the base source information and generate a corresponding base layer quality signal. Those devices able to recover source information for one or more enhancement layers will be able to combine that recovered information with the base layer recovered information to generate one or more enhanced level signals (e.g., enhanced level signal (S1) through enhanced level signal (Sn)).

Also, a given recipient device 120-122 may be configured to recover source information associated with the base layer and a highest possible enhancement layer that the recipient device 120-122 successfully receives. In some instances, a recipient device 120-122 may change among various enhancement layers depending on changed operating conditions. For example, at one time, recipient device 120-122 may be able to recover only base layer source information. At another time, recipient device 120-122 may be able to recover at least one enhancement layer's source information. A recipient device 120-122 may generate signals of different respective quality at different respective times based on what source information is able to recover.

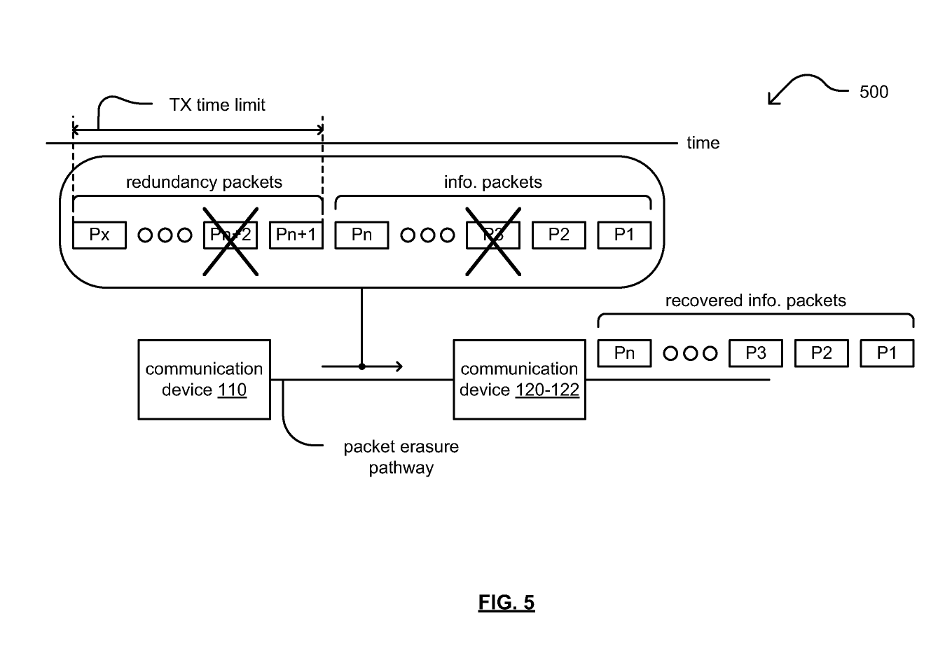

FIG. 5 is a diagram illustrating an example 500 of communication between two communication devices via a packet erasure pathway. Packets are transmitted from device 110 to one or more of the devices 120-122. These packets are transmitted via a packet erasure pathway that may be characterized as any given one of the packets either being received by device 120-122 or lost/erased during transmission. There may be instances in which a packet is received by device 120-132 yet is somehow adversely affected. In the diagram, the packets of a particular layer (e.g., base layer or one of the redundancy layers) are shown as including information packets and redundancy packets. The amount of redundancy packets associated with a given number of information packets is based on a number of parameters including the type of FEC employed, the code rate of the FEC, the source information block or symbol size, etc.

In the example packet erasure pathway of this diagram, information packet P3 and redundancy packet Pn+2 are shown as being lost/erased (i.e., crossed out in the diagram). Even with the loss of one or more information packets and/or one or more redundancy packets, when a sufficient number of redundancy packets are received, device 120-122 is able to generate the recovered information packets including the packet P3 that was lost/erased during transmission. Device 120-122 is able to generate one or more lost/erased packets based on redundancy included within the one or more redundancy packets.

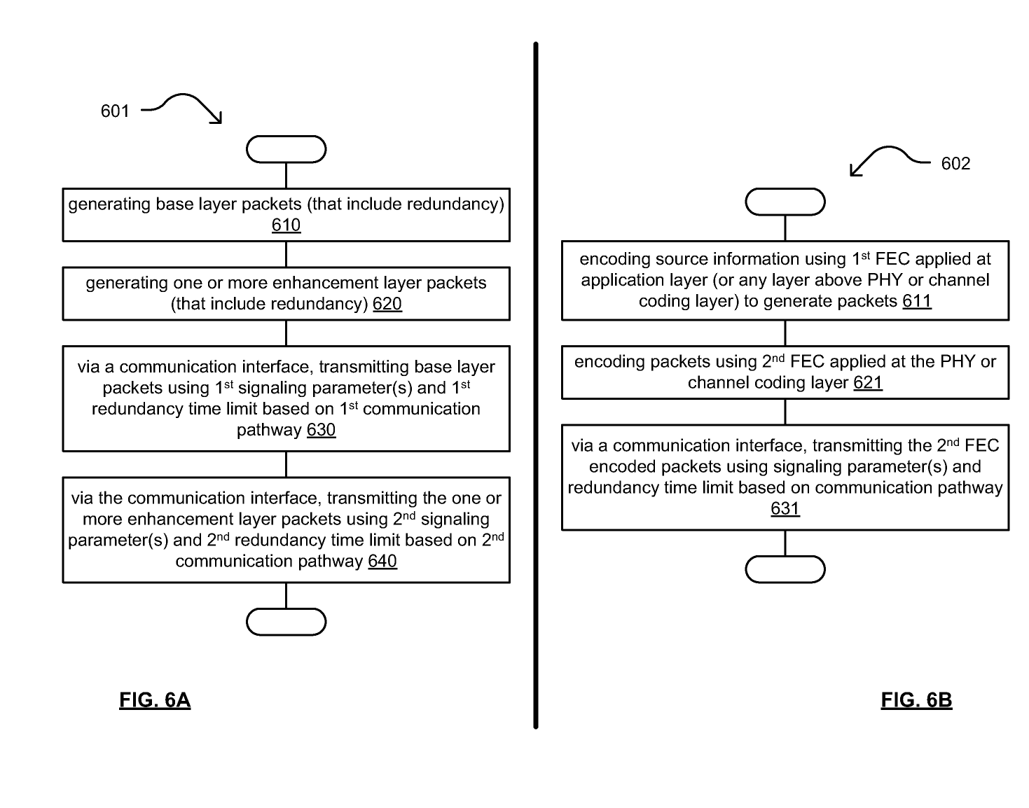

FIG. 6A is a diagram illustrating an embodiment of a method 601 for execution by one or more communication devices. The method 601 operates by generating base layer packets as shown in block 610. These base layer packets include one or more base layer information packets and one or more base layer redundancy packets. The method 601 continues by generating one or more enhancement layer packets as shown in block 620. The enhancement layer packets may correspond to more than one enhancement layer. For any given layer, the method 601 generates enhancement layer information packets and one or more enhancement layer redundancy packets.

Via a communication interface of a communication device, the method 601 operates by transmitting base layer packets using 1^{st} signaling parameter(s) and 1^{st} redundancy time limit based on 1^{st} communication pathway as shown in block 630. Also, via the communication interface, the method 601 operates by transmitting the one or more enhancement layer packets using 2^{nd} signaling parameter(s) and 2^{nd} redundancy time limit based on 2^{nd} communication pathway as shown in block 640.

FIG. 6B is a diagram illustrating another embodiment of a method 602 for execution by one or more communication devices. The method 602 operates by encoding source information using 1^{st} FEC applied at application layer (or any layer above physical layer (PHY) or channel coding layer) to generate packets as shown in block 611. The source information may correspond to the base layer or any one or more of the enhancement layers. The method 602 continues by encoding packets using 2^{nd} FEC applied at the PHY or channel coding layer as shown in block 621. At least two respective levels of FEC are applied to generate the packets that are eventually transmitted via a communication interface of the device, namely, at the PHY or channel coding layer as well as at an application layer. Generally, at least two respective levels of FEC are applied at the PHY or channel coding layer and at least one higher layer (e.g., the application layer or at least one other layer above the PHY or channel coding layer) to generate the packets. Via the communication interface of the communication device, the method 602 operates by transmitting the 2^{nd} FEC encoded packets using signaling parameter(s) and redundancy time limit based on communication pathway as shown in block 631.

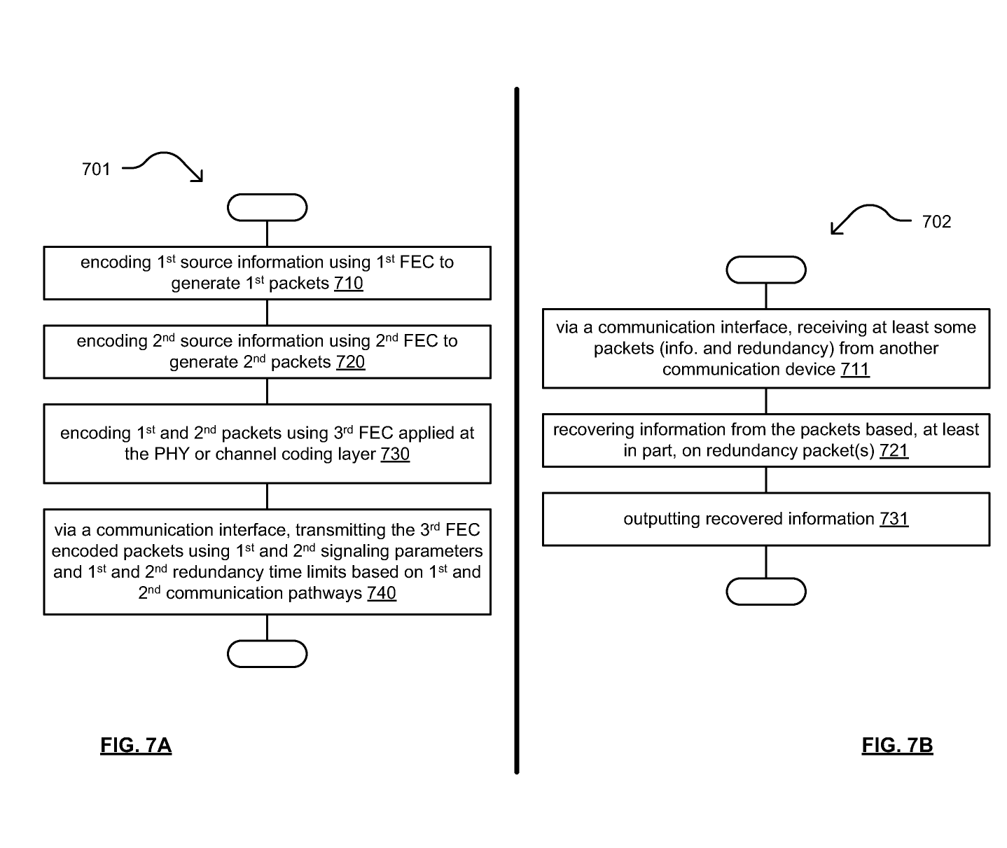

FIG. 7A is a diagram illustrating another embodiment of a method 701 for execution by one or more communication devices. The method 701 operates by encoding 1^{st} source information using 1^{st} FEC to generate 1^{st} packets shown in block 710. The method 701 continues by encoding 2^{nd} source information using 2^{nd} FEC to generate 2^{nd} packets as shown in block 720. The method 701 then operates by encoding 1^{st} and 2^{nd} packets using 3^{rd} FEC applied at the PHY or channel coding layer as shown in block 730. At least one of the 1^{st} and 2^{nd} packets generated by the 1^{st} FEC and the 2^{nd} FEC, respectively, undergoes subsequent encoding at least PHY or channel coding layer. VA communication interface of a communication device, the method 701 continues by transmitting the 3^{rd} FEC encoded packets using 1^{st} and 2^{nd} signaling parameters and 1^{st} and 2^{nd} redundancy time limits based on 1^{st} and 2^{nd} communication pathways as shown in block 740. Different respective FEC's may be applied to different respective source information at one or both of the application layer and the PHY or channel coding layer. Also, different respective signaling parameters and different respective redundancy time limits may be applied to the different respective layers that are transmitted from a transmitter device to one or more recipient devices.

FIG. 7B is a diagram illustrating another embodiment of a method 702 for execution by one or more communication devices. Via a communication interface of a communication device, the method 702 operates by receiving at least some packets (info. and redundancy) from another communication device as shown in block 711. The method 702 continues by recovering information from the packets based, at least in part, on redundancy packet(s) as shown in block 721. The method 702 then operates by outputting recovered information as shown in block 731.

The present invention has been described herein with reference to at least one embodiment. Such embodiment(s) of the present invention have been described with the aid of structural components illustrating physical and/or logical components and with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims that follow. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may also be used herein, the terms “processing module,” “processing circuit,” “processing circuitry,” and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module includes a processing module, a functional block, hardware, and/or software stored on memory for performing one or more functions as may be described herein. Note that, if the module is implemented via hardware, the hardware may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure of an invention is not limited by the particular examples disclosed herein and expressly incorporates these other combinations.

What is claimed is:

1. A communication device comprising:
a processor configured to generate base layer packets, which include base layer redundancy packets, and enhancement layer packets, which include enhancement layer redundancy packets, which modify quality of the base layer packets; and
a communication interface configured to:
transmit the base layer packets to a plurality of other communication devices using one or more first signaling parameters and a first redundancy time limit based on a first characteristic of a first communication pathway between the communication device and a first one of the plurality of other communication devices; and
transmit the enhancement layer packets to the plurality of other communication devices using one or more second signaling parameters and a second redundancy time limit based on a second characteristic of a second communication pathway between the communication device and a second one of the plurality of other communication devices.

2. The communication device of claim 1, wherein the processor is further configured to generate the base layer redundancy packets by encoding first symbols using a first forward error/erasure correction (FEC) code and to generate the enhancement layer redundancy packets by encoding second symbols using a second FEC code.

3. The communication device of claim 1, wherein the processor is further configured to generate the base layer redundancy packets by encoding first symbols using a first forward error/erasure correction (FEC) code and to generate the enhancement layer redundancy packets by encoding second symbols using a second FEC code that has relatively less error correction capability than the first FEC code; and
a first ratio of the base layer redundancy packets to the base layer packets is relatively larger than a second ratio of the enhancement layer redundancy packets to the enhancement layer packets.

4. The communication device of claim 1, wherein the processor is further configured to perform scalable encoding to encode a first source block using a first forward error/erasure correction (FEC) code to generate the base layer packets and to encode a second source block, which has a common size as the first source block, using a second FEC code that has a relatively smaller code rate than the first FEC code to generate the enhancement layer packets.

5. The communication device of claim 1, wherein the processor is further configured to generate the base layer redundancy packets and the enhancement layer redundancy packets by encoding symbols using a first one or more forward error/erasure correction (FEC) codes applied at an application layer; and
the processor is further configured to channel encode the base layer packets and the enhancement layer packets using a second one or more FEC codes applied at a physical layer.

6. The communication device of claim 1, wherein the communication interface is further configured to modify the one or more first signaling parameters based on change of the characteristic of the first communication pathway and to modify the one or more second signaling parameters based on change of the characteristic of the second communication pathway.

7. The communication device of claim 1, wherein the processor is further configured to generate the base layer packets and the enhancement layer packets based on media that includes at least one of video content and audio content; and
the communication interface is further configured to broadcast or stream the base layer packets and the enhancement layer packets via a plurality of communication pathways that includes the first communication pathway and the second communication pathway.

8. The communication device of claim 7, wherein the plurality of communication pathways include a plurality of packet erasure pathways; and
any one of the base layer packets and enhancement layer packets is either successfully received by at least one of the plurality of other communication devices or lost during transmission via one of the plurality of packet erasure pathways.

9. A communication device comprising:
a processor configured to:
encode first symbols using a first forward error/erasure correction (FEC) code to generate base layer packets that include base layer redundancy packets; and
encode second symbols using a second FEC code, which has relatively less error correction capability than the first FEC code, to generate enhancement layer packets that include enhancement layer redundancy packets and that modify quality of the base layer packets; and
a communication interface configured to:
transmit the base layer packets to a plurality of other communication devices using one or more first signaling parameters and a first redundancy time limit based on a first characteristic of a first communication pathway between the communication device and a first one of the plurality of other communication devices; and
transmit the enhancement layer packets to the plurality of other communication devices using one or more second signaling parameters and a second redundancy time limit based on a second characteristic of a second communication pathway between the communication device and a second one of the plurality of other communication devices.

10. The communication device of claim 9, wherein the processor is further configured to encode the first symbols using the first FEC code applied at an application layer; and
the processor is further configured to channel encode the base layer packets and the enhancement layer packets using a one or more additional FEC codes applied at a physical layer.

11. The communication device of claim 9, wherein the communication interface is further configured to modify the one or more first signaling parameters based on change of the characteristic of the first communication pathway and to modify the one or more second signaling parameters based on change of the characteristic of the second communication pathway.

12. The communication device of claim 9, wherein the first symbols and the second symbols are based on media that includes at least one of video content and audio content; and
the communication interface is further configured to broadcast or stream the base layer packets and the enhancement layer packets via a plurality of communication pathways that includes the first communication pathway and the second communication pathway.

13. The communication device of claim 12, wherein the plurality of communication pathways include a plurality of packet erasure pathways; and
any one of the base layer packets and enhancement layer packets is either successfully received by at least one of the plurality of other communication devices or lost during transmission via one of the plurality of packet erasure pathways.

14. A method for execution by a communication device, the method comprising:
generating base layer packets, which include base layer redundancy packets, and enhancement layer packets, which include enhancement layer redundancy packets, which modify quality of the base layer packets; and
via a communication interface of the communication device:
transmitting the base layer packets to a plurality of other communication devices using one or more first signaling parameters and a first redundancy time limit based on a first characteristic of a first communication pathway between the communication device and a first one of the plurality of other communication devices; and
transmitting the enhancement layer packets to the plurality of other communication devices using one or more second signaling parameters and a second redundancy time limit based on a second characteristic of a second communication pathway between the communication device and a second one of the plurality of other communication devices.

15. The method of claim 14 further comprising:
generating the base layer redundancy packets by encoding first symbols using a first forward error/erasure correction (FEC) code; and
generating the enhancement layer redundancy packets by encoding second symbols using a second FEC code.

16. The method of claim 14 further comprising:
generating the base layer redundancy packets by encoding first symbols using a first forward error/erasure correction (FEC) code;
generating the enhancement layer redundancy packets by encoding second symbols using a second FEC code that has relatively less error correction capability than the first FEC code; and wherein a first ratio of the base layer redundancy packets to the base layer packets is relatively larger than a second ratio of the enhancement layer redundancy packets to the enhancement layer packets.

17. The method of claim 14 further comprising:
performing scalable encoding to encode a first source block using a first forward error/erasure correction (FEC) code to generate the base layer packets; and
performing scalable encoding to encode a second source block, which has a common size as the first source block, using a second FEC code that has a relatively smaller code rate than the first FEC code to generate the enhancement layer packets.

18. The method of claim 14 further comprising:
generating the base layer redundancy packets and the enhancement layer redundancy packets by encoding symbols using a first one or more forward error/erasure correction (FEC) codes applied at an application layer; and
channel encoding the base layer packets and the enhancement layer packets using a second one or more FEC codes applied at a physical layer.

19. The method of claim 14 further comprising:
modifying the one or more first signaling parameters based on change of the characteristic of the first communication pathway and to modify the one or more second signaling parameters based on change of the characteristic of the second communication pathway.

20. The method of claim 14 further comprising:
generating the base layer packets and the enhancement layer packets based on media that includes at least one of video content and audio content; and
broadcasting or streaming the base layer packets and the enhancement layer packets via a plurality of communication pathways that includes the first communication pathway and the second communication pathway, wherein the plurality of communication pathways include a plurality of packet erasure pathways such that any one of the base layer packets and enhancement layer packets is either successfully received by at least one of the plurality of other communication devices or lost during transmission via one of the plurality of packet erasure pathways.
